(19) United States
(12) Patent Application Publication
(10) Pub. No.: US 2026/0298894 A1
(43) Pub. Date: Oct. 1, 2026

(54) BATCH EFFECT DETECTION AND ADJUSTMENTS OF LC-MS DATA

(71) Applicant: Donald Danforth Plant Science Center, St. Louis, MO (US)

(72) Inventors: Allen Hubbard, St. Louis, MO (US); Ivan Baxter, St. Louis, MO (US); Louis Connelly, St. Louis, MO (US)

(21) Appl. No.: 19/489,359

(22) PCT Filed: Jun. 3, 2024
(86) PCT No.: PCT/US2024/032248

§ 371 Date: Dec. 2, 2025

Related U.S. Application Data
(60) Provisional application No. 63/505,935, filed on Jun. 2, 2023.

(51) Int. Cl. G01N 30/86; G01N 30/02; G01N 30/72

(52) U.S. Cl. CPC G01N 30/8658; G01N 30/7233; G01N 2030/027

(57) ABSTRACT

Systems and methods are provided for detecting and correcting batch effects within chromatography-MS data files. Chromatography-MS files of signal measurements for different batches may be received from an LC-MS machine and merged into a series of merged files for each respective batch. One batch may be designated a reference batch, and its merged file designated a reference merged file. Each quantile of the merged file for each individual batch may be compared to a corresponding quantile of the reference merged file. The differences in signal measurements may be identified between each corresponding quantile. A correction factor identified relative to the reference batch, which may correspond to an average of the differences in signal measurements identified for the respective quantile of the individual batch. The data file of the individual batch may be adjusted by modifying the signal measurements of each quantile based on the corresponding correction factor.

### CROSS-REFERENCE TO RELATED APPLICATIONS

This application claims priority from Provisional Application No. 63/505,935, filed Jun. 2, 2023, the entire contents of which are hereby incorporated by reference.

### GOVERNMENTAL RIGHTS

This invention was made with government support under DE-SC0018277 and DESC0023160 awarded by the Department of Energy. The government has certain rights in the invention.

### FIELD OF THE INVENTION

The present disclosure relates generally to chromatography-mass spectrometry (chromatography-MS) data files. More specifically, the present disclosure relates to detecting batch effects in and adjusting chromatography-MS data files based on the detected batch effects.

### BACKGROUND OF THE INVENTION

Liquid chromatography-mass spectrometry (LC-MS) is a chemical technique that relies on two dimensions of separation to identify different compounds in a sample as unique mass features. An LC-MS machine can include a liquid chromatography system that can separate the different compounds by structural properties, while an associated mass spectrometer component subsequently determines the mass and intensity (e.g., mass-to-charge or m/z signals) of the ions that elute from the chromatography column. Modern high-resolution mass spectrometry can now detect and quantify ions with high mass precision (<5 ppm mass error) but can also result in significant amounts of noise. When a sample is analyzed by an LC-MS machine, the results can be included in a data file documenting data regarding a plurality of signals corresponding to and indicative of the various compounds at different relative abundance within the sample.

Currently available LC-MS analytical techniques generally rely on targeted matching to known compounds. Such targeting techniques require, however, knowledge of the compounds within a given sample in order to compare the LC-MS data for known standards. Such knowledge is often lacking for certain types of samples (e.g., metabolomics), which can include dozens of samples for which the associated LC-MS data files can include tens of thousands of different raw signals. Different subsets of the signals can correspond to different compounds present in different amounts within a given tissue sample, while other signals can merely be noise.

One of the challenges in harnessing LC-MS data for untargeted analysis (e.g., of metabolomics), when done at scale needed for clinical or population scale studies, is having to correct for batch effects that can cause variations from batch to batch. Such batch effects can arise from intrinsic instrumentation variability (e.g., in reliability, sensitivity, and/or based on different conditions) when applied at different times upon different batches, despite otherwise identical settings. In addition to machine conditions, batch effects can also arise from sample preparations or interactions with the machine conditions. Such effects can further be specific to a particular metabolite, whereby the signal measurements associated with each metabolite can exhibit different batch effects across different batches. As a result of such batch effects, signals that would otherwise be indicative of biomarkers or other compounds can be obscured.

Batch effects can include signal intensity variations or fluctuations across different batches for each individual metabolite. Batch effects can also include variations due to space charge where instruments can be too sensitive. Such batch effects can obscure biological signals of important biomarkers. Even after correcting for retention time and mass drift due to calibration issues, substantial variation in signal quality across batches is common. These batch effects can be due to machine condition, sample preparation, or an interaction of the two.

The current solution to address batch effects in metabolomics is to use large sets of standards present in quality control samples, which can be matched up to corresponding signals in experimental samples. Under this type of design, variation related to batch can be determined and regressed out from metabolites that match to standards or are determined to be comparable in behavior (i.e., similar compound classes). Such standards-based analytical processes can use quality control samples to quantify the batch effect for individual metabolites that can be subsequently regressed out of the data. This process can be laborious, and time-intensive, however, as well as limited by the set of known reference standards that can vary from lab to lab. It can therefore be highly impractical and inefficient to correct for batch effects in accordance with such traditional solutions.

There is, therefore, a need in the art for improved systems and methods of batch effect detection and corresponding adjustments to LC-MS data.

### SUMMARY OF THE INVENTION

One embodiment of the instant disclosure encompasses a method for correcting batch effects of liquid chromatograph-mass spectrometry (chromatography-MS) data files. The method comprises: (a) receiving or having received a plurality of data files corresponding to different batches evaluated by a liquid chromatography-mass spectrometer machine, each data file including a set of signal intensity measurements regarding a corresponding batch as measured by the liquid chromatography-mass spectrometer machine; (b) combining the received data files for each batch into individual merged data files, each merged data file containing a combined set of raw signal intensity measurements from all data files of the respective batch; (c) designating one of the batches as a reference batch, wherein a merged data file for the reference batch is designated as a reference file; (d) comparing each mass-based quantile of the merged data file for each individual batch to a corresponding quantile of the reference file for the reference batch, wherein differences in signal intensity measurements are identified between each mass-based quantile of the merged data file for the individual batch and the corresponding mass-based quantile of the reference file; (e) identifying an intensity correction factor for each mass-based quantile of the individual batch relative to the reference batch, wherein the intensity correction factor reflects the differences in signal intensity measurements identified for the respective mass-based quantile of the individual batch; and (f) adjusting the data file of the individual batch, wherein adjusting the data file includes modifying the signal intensity measurements of each mass-based quantile of the individual batch based on the corresponding intensity correction factor to normalize the signal intensity measurements of the corresponding mass-based quantile of the merged reference data files. In some embodiments, the intensity correction factor corresponds to an average of the differences in signal intensity measurements identified for the respective mass-based quantile of the individual batch.

The method can further comprise performing the adjustments on a mass feature by mass feature basis, wherein each mass feature corresponds to a specific compound present within the batch sample. In some embodiments, each batch includes a plurality of samples, and the associated merged data file includes signal measurements for the plurality of samples. In some embodiments, the method further comprises summing the signal intensity measurements across multiple batch samples to identify mass features within certain bounds, wherein the mass features are indicative of specific compounds present within the batch sample.

The method can further comprise generating a map that visually illustrates the modified signal intensity measurements of each mass-based quantile of the individual batch based on the adjusted data file. The method can also further comprise updating the merged data file for the individual batch based on the adjusted data file. In some embodiments, the method further comprises generating a map based on the updated merged data file.

The method can further comprise identifying one or more imputed signals for the individual batch based on the updated merged data file, wherein the imputed signals are missing from one or more of the data files of the individual batch. In some embodiments, identifying the imputed signals is based on comparing a Gaussian distribution of a mass feature in the updated merged data file to a corresponding Gaussian distribution of the data file of the individual batch.

The method can further comprise adjusting space-charge mass drift in a mass feature exhibiting space-charge mass drift. In some embodiments, adjusting space-charge mass drift in a mass feature exhibiting space-charge mass drift comprises applying a mass-based adjustment to the data file of the individual batch along the mass domain of the mass feature. In some embodiments, adjusting space-charge mass drift in a mass feature exhibiting space-charge mass drift comprises: identifying a plurality of intensity-based quantiles for the merged data file; identifying a mass correction factor for each intensity-based quantile of the individual batch relative to the reference batch, wherein the mass correction factor reflects the differences in mass intensity measurements identified for the respective intensity-based quantile of the individual batch; and applying the mass-based adjustment to the data file based on the mass correction factor identified for each of the intensity-based quantiles. In some embodiments, the mass correction factor corresponds to an average of the differences in intensity measurements identified for the respective intensity-based quantile of the individual batch. In some embodiments, the method further comprises identifying mass features exhibiting space-charge mass drift. In some embodiments, identifying mass features exhibiting space-charge mass drift comprises identifying a split along a mass domain of a mass feature in a merged data file, wherein a split along a mass domain of the mass feature is indicative of space-charge mass drift. In some embodiments, wherein a mass-based adjustment is applied to the data file of the individual batch along the mass domain of the mass feature before correcting batch effects of the data files.

Another embodiment of the instant disclosure encompasses a computing system for correcting batch effects of liquid chromatograph-mass spectrometry (chromatography-MS) data files. The system comprises: (a) a communication interface that receives EICs of portions of each of a plurality of MS chromatograms; and (b) a processor that executes instructions stored in memory. The processor executes the instructions to correct batch effects of liquid chromatograph-mass spectrometry (chromatography-MS) data files. In some embodiments, correcting batch effects of liquid chromatograph-mass spectrometry (chromatography-MS) data files can be as described herein above.

### BRIEF DESCRIPTION OF THE FIGURES

The following drawings form part of the present specification and are included to further demonstrate certain embodiments of the present disclosure. Certain embodiments can be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIG. 1 illustrates an exemplary process by which a batch of multiple samples is evaluated by a liquid chromatography-mass spectrometer (LC-MS) machine and a map of identified signals.

FIG. 2 illustrates an exemplary map of a combined set of LC-MS signal measurements across multiple different batches, each of which can correspond to respective batch effects.

FIG. 3 illustrates an example of how batch-specific conditions create batch effects specific to the resulting set of batch data and corresponding map.

FIG. 4 illustrates exemplary maps of signal data for different individual batches and an exemplary combination map of the signal data across the set of batches.

FIG. 5 illustrates a close-up view of the exemplary maps of signal data for the different individual batches.

FIG. 6 illustrates exemplary maps of signal data for the different individual batches before and after quantile-based adjustment.

FIG. 7 illustrates exemplary graphs of individual signal intensity ranges for different batches before and after quantile-based adjustment.

FIG. 8 illustrates exemplary graphs of combined signal intensity ranges by category before and after quantile-based adjustment.

FIG. 9 illustrates exemplary combined sets of signal data for different batches before and after quantile-based adjustment.

FIG. 10 illustrates exemplary combination maps of signal data for different batches before and after quantile-based adjustment where the adjusted combination map can be used to impute signals.

FIG. 11 illustrates exemplary maps of signal data for different individual batches subject to space charge effects and an exemplary combination map of the signal data across the set of batches.

FIG. 12 illustrates a close-up view of the exemplary combination map of the signal data across the set of batches.

FIG. 13 illustrates exemplary quantile slices within the combination of signal data.

FIG. 14 illustrates adjusted maps of signal data for different individual batches subject to space charge effects and an exemplary combination map of the adjusted signal data across the set of batches.

FIG. 15 is a flowchart illustrating an exemplary method for correcting batch effects of liquid chromatograph-mass spectrometry data files.

FIG. 16 illustrates an example of a system for implementing certain embodiments of the present technology.

### DETAILED DESCRIPTION

Embodiments of the present disclosure include systems and methods of detecting and correcting batch effects within chromatograph-mass spectrometry (chromatography-MS) data files. The inventors devised methods of detecting and correcting batch effects in liquid chromatography-mass spectrometry (LC-MS) data files without relying on known or physical standards. Traditional methods require knowledge of the compounds within a sample and use large sets of standards present in quality control samples to quantify and correct batch effects. The methods of the instant disclosure can correct of batch effects without the need for known standards, making it more computationally efficient and reducing the resource costs associated with high-throughput metabolomics. The methods can be used to improve the quality and reproducibility of large-scale untargeted metabolomics and broaden the applicability of the techniques to various scientific fields, including plant, animal, and medical sciences.

### I. Methods

Embodiments of the present disclosure encompass methods of detecting and correcting batch effects within chromatograph-mass spectrometry (chromatography-MS) data files. Chromatography-MS files of signal measurements for different batches can be received from an LC-MS machine and merged into a series of merged files for each respective batch. One batch can be designated a reference batch, and its merged file designated a reference merged file. Each quantile of the merged file for each individual batch can be compared to a corresponding quantile of the reference merged file. The differences in signal intensity measurements (signal measurements) can be identified between each corresponding quantile. A correction factor identified relative to the reference batch, which can correspond to an average of the differences in signal measurements identified for the respective quantile of the individual batch. The data file of the individual batch can be adjusted by modifying the signal measurements of each quantile based on the corresponding correction factor.

### (a) Method Steps

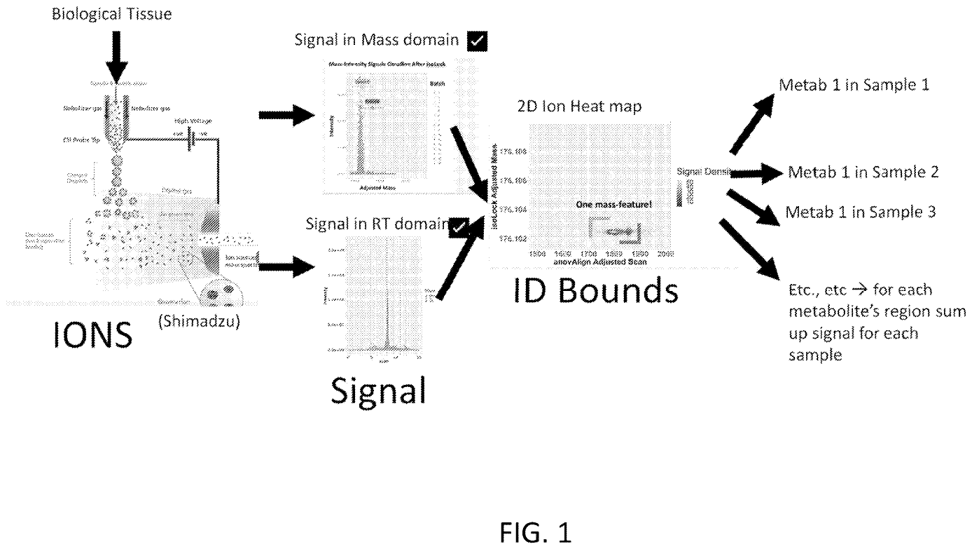

FIG. 1 illustrates an exemplary process by which a batch of multiple samples is evaluated by a liquid chromatography-mass spectrometer (LC-MS) machine and a map of identified signals. As illustrated in FIG. 1, a biological tissue batch sample can be combined with mobile phase and carried by a nebulizer gas through an electrospray ionization (ESI) probe tip. The ESI probe tip can apply a high voltage to create charged droplets, which can be exposed to drying gas. As a result of the exposure to the drying gas, the droplets can undergo desolvation (under an ion evaporation model) whereby solvent in the droplets can evaporate to leave gas phase ions that are then evaluated by mass spectrometry.

The evaluation can include generating a chromatogram that includes signals along a mass domain and along a retention time (RT) domain. The identified signals (e.g., mass-to-charge ratios) can be saved to data files, which can be subject to further analyses to identify the compounds present in the biological sample and properties thereof. Such additional analysis can include mapping the signals in a two-dimensional (2D) ion heat map in which different clusters of signals appear mapped to similar mass and retention times. When the signals are summed up across multiple batch samples, the result can include mass features within certain bounds. Such mass features can be indicative of specific compounds (e.g. metabolites) being present within the batch sample. In the absence of any batch-specific effects, it would be expected that samples of the same biological tissue would result in similar mass features. Where batch effects can create variations across different batch evaluation results, however, the mass features can become more difficult to discern, thereby presenting an obstacle to accurate assessments of the biological tissue.

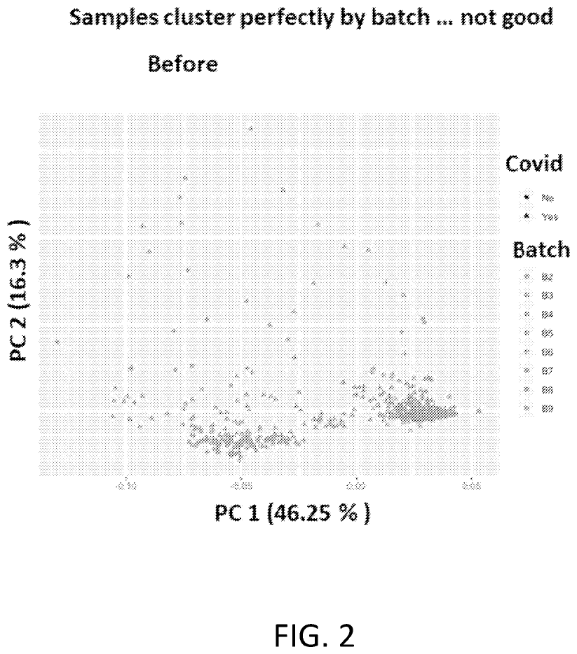

FIG. 2 illustrates an exemplary map of a combined set of LC-MS signal measurements across multiple different batches each of which can correspond to respective batch effects. As illustrated in the map of FIG. 2, multiple different batches can be categorized based on coronavirus (COVID) status. When the signals associated with the multiple different batches are mapped, the resulting map shows that the samples cluster closely by batch, indicating the presence of batch-specific effects that create consistent or recurring differences between the signals of one batch and the signals of another batch. For example, a COVID mass feature corresponding to a set of signals for one batch can cluster about a different mass or signal intensity than the COVID mass feature corresponding to a set of signals for another batch. Such variability can create too much noise within the resulting data to provide reliable or accurate results.

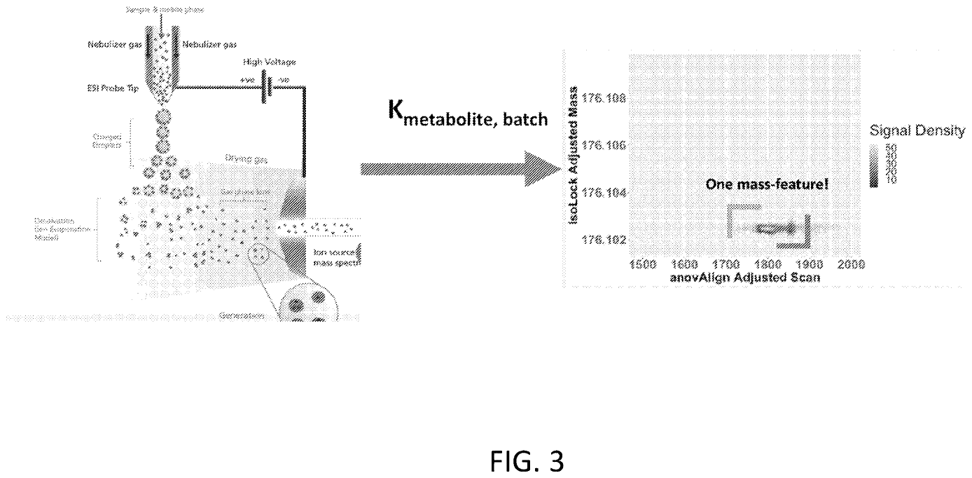

FIG. 3 illustrates an example of how batch-specific conditions create batch effects specific to the resulting set of batch data and corresponding map. In FIG. 3, Kmetabolite, batch represents the conditions affecting the translation of the ion cloud to signals for each metabolite and which can result in different batch effects. In particular, the batch samples from the same biological tissue can be subject to the same LC-MS processes (e.g., nebulization, ionization, drying, desolvation, etc.), but due to Kmetabolite, batch, can result in different signal readings that adversely affect the ability to discern mass features indicative of compounds within the biological tissue. Where a particular compound (e.g., metabolite) can be only present in tissue in low or trace (e.g., e³-e⁵) amounts, such batch effects can effectively mask the signal peaks that can otherwise be indicative of the presence of the compound.

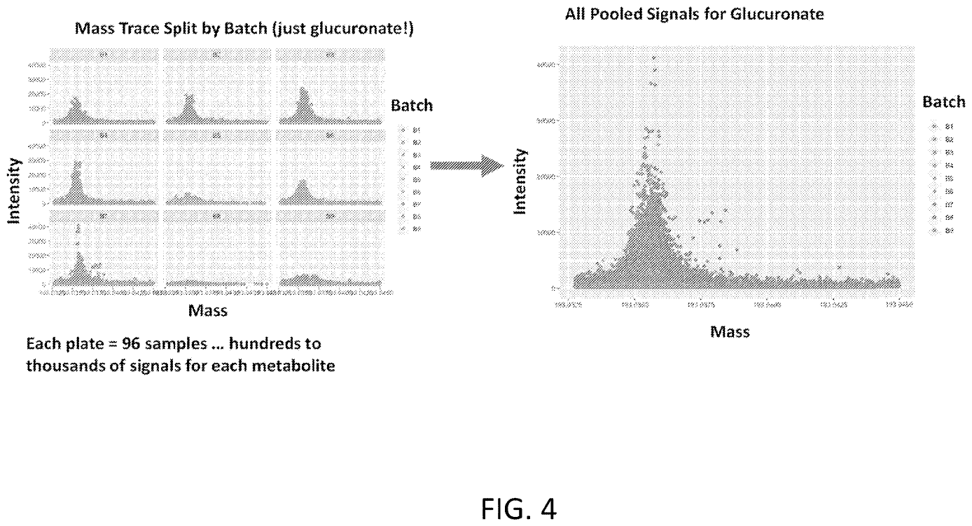

FIG. 4 illustrates exemplary maps of signal data for different individual batches and an exemplary combination map of the signal data across the set of batches. As noted, each batch can correspond to a plate of multiple samples (e.g., 96 samples) that is evaluated in a single run of the LC-MS machine. Each map of an individual batch visually illustrates a set of signals along axes corresponding to mass and charge intensity. When pooled or combined into a single combination map (e.g., map that includes data from multiple different batches), the combined signals can form a more distinct peak than the peaks of the individual maps.

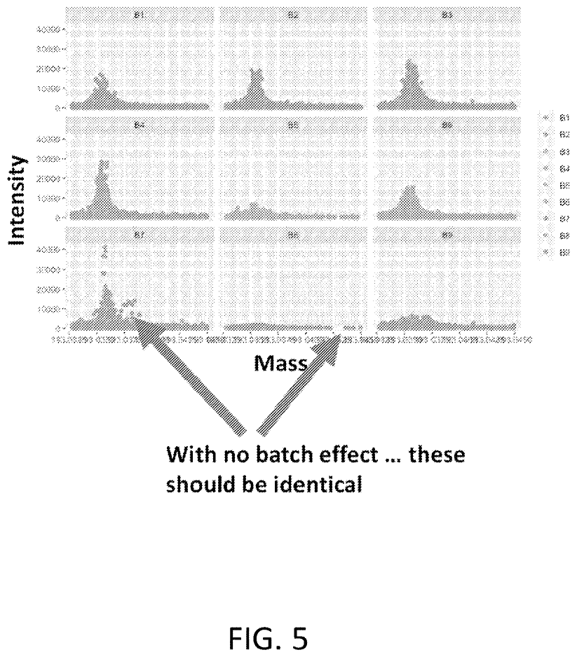

FIG. 5 illustrates a close-up view of the exemplary maps of signal data for the different individual batches. Assuming that each batch is subject to randomization, such randomization should be independent and identically distributed, and the combined or pooled signals for each individual batch should otherwise be identical. Due to batch effects specific to the individual batch, however, some variability is introduced into the mapped signals for the respective batch. As a result, the map for one batch can include a peak having different masses or intensities than the map for another batch. Thus, a comparison of signals from across different batches (associated with the same biological tissue) can be used to detect batch effects that create variation in the signals of the different batches. Such batch effects need to be mitigated and otherwise corrected in order to provide a more accurate evaluation of the biological tissue being analyzed by the batch runs.

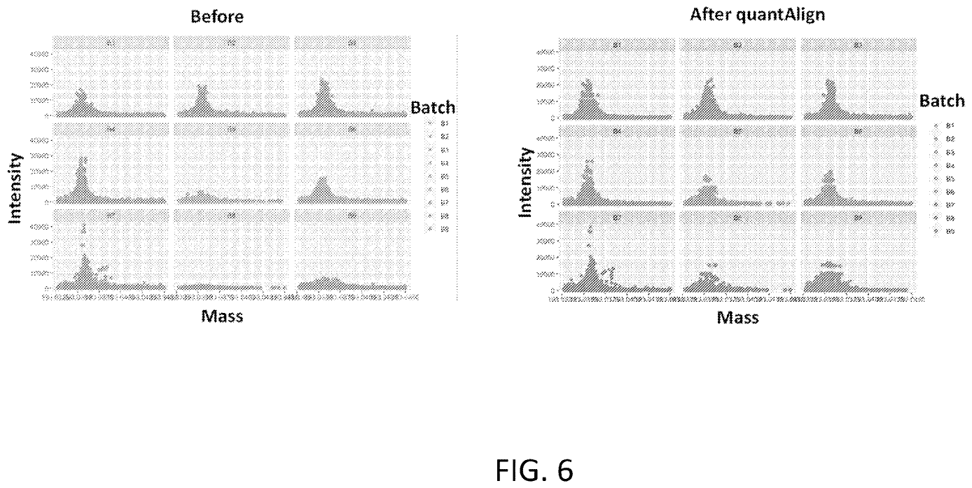

FIG. 6 illustrates exemplary maps of signal data for the different individual batches before and after quantile-based adjustment. Quantile-based adjustments can be applied without relying on standards and entails generating a merged file for each individual batch. As any individual batch contains dozens of samples, the merged file potentially includes data regarding many dozens of thousands of raw signals that allow for a Gaussian signal profile to be formed across all signals (from dozens of samples in that batch) and to become pronounced for each batch. One of these batches' merged file is designated as the reference against which the other batches are aligned, thereby creating a consistent signal across batches. The signals associated with the reference batch can be merged into a data file that is designated a reference file.

Once the data files for each batch are pooled together (for each metabolite, there can be thousands to many thousands of signals for all samples in a batch), their distribution to the pooled signals from all samples for that same metabolite in another batch (the designated reference batch) by quantile. Thus, each merged data file can be divided into an ordered sequence of quantiles (e.g., from top to bottom of the Gaussian signal intensity profile), and each quantile is compared to a corresponding quantile of the reference file. For example, a first quantile (e.g., >99th percentile) of a respective data file for each batch is compared to the first quantile (e.g., >99th percentile) of the reference file, a second quantile (e.g., 99th-98th percentile) of a respective data file for each batch is compared to the second quantile (e.g., 99th-98th percentile) of the reference file, and so on.

The differences in each quantile of the Gaussian distributions of the compositive intensity and m/z signal profile in each batch can be determined relative to the corresponding quantile of the reference batch. The quantile-based adjustments rely on standard assumptions of traditional batch normalization, such as randomization across batches and homogeneity of each batch). By pooling signals across multiple dozens of samples per batch, however, an improved and fuller depiction of the signal distribution of the metabolite in that batch can be achieved, which further allows for normalization without relying on standards. In particular, quantile-based adjustments can use the Gaussian signal profile for the intensity vs m/z value of a given metabolite in one batch to match that of the same metabolite in another batch. The differences are therefore identified being due to the influence of batch effects. Utilizing the merged mass spectrum further ensures that sufficient statistical power is available to implement an effective calculation of batch effects, thereby avoiding the risk of overfitting which is virtually inevitable under current modeling approaches.

A correction factor can be identified for each quantile based on an average of the differences identified between the quantile and the corresponding quantile of the reference file. Each quantile can therefore be corrected or adjusted in accordance with the identified correction factor. Such correction can include an adjustment to the respective intensity of each quantile in accordance with the determined correction factor. When the respective data files for each batch are updated in accordance with the adjustment and mapped, the resulting maps show a peak with a more consistent Gaussian distribution across the different batches. Thus, the adjustment matches corresponding quantiles within the respective Gaussian of each batch's merged data.

The correction factor can reflect various statistical values other than the average. For instance, it can be based on the median, which provides a measure of central tendency that is less affected by outliers. Alternatively, the correction factor can be determined using the mode, representing the most frequently occurring difference in signal intensity measurements. In some cases, the correction factor can also be derived from a weighted average, where certain differences are given more importance based on predefined criteria. Additionally, the correction factor can be calculated using robust statistical methods such as the trimmed mean, which excludes extreme values to provide a more stable estimate. These alternative values allow for flexibility in addressing different types of batch effects and improving the accuracy of the adjustments.

As illustrated in FIG. 6, the map for each individual batch exhibits more variability across the different batches before quantile-based adjustments are applied to the respective batch data. Following the adjustment of each quantile in each batch in accordance with the correction factor, the mass feature becomes more discernible and aligned across the different batches as illustrated in the maps of the adjusted signals.

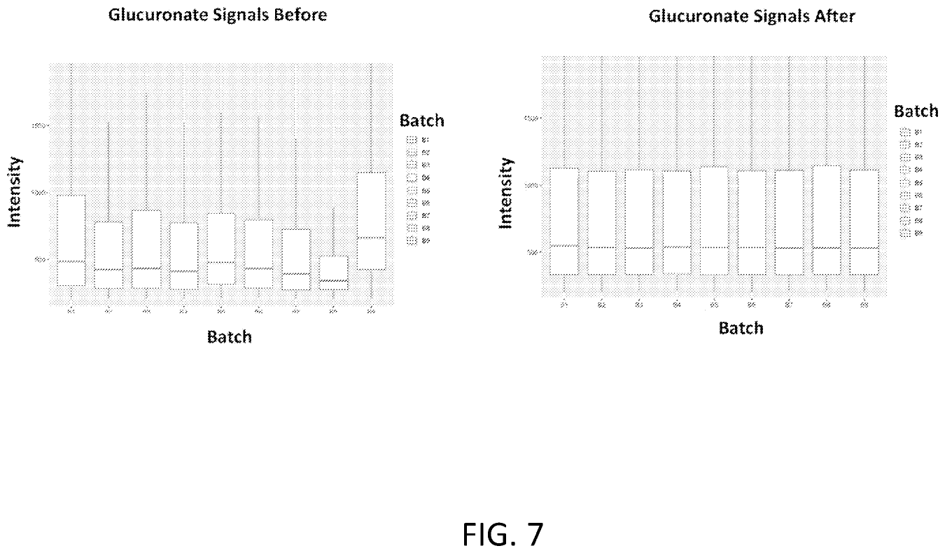

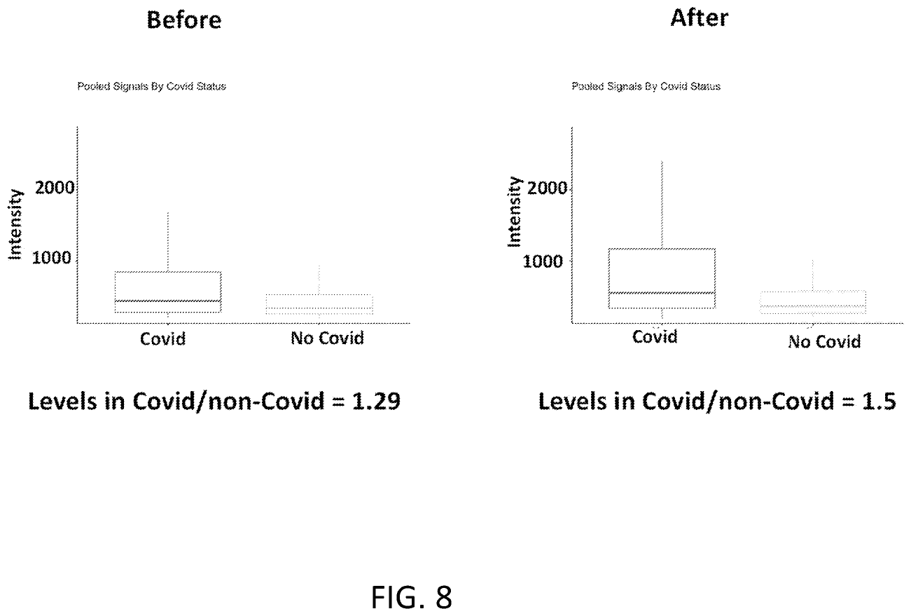

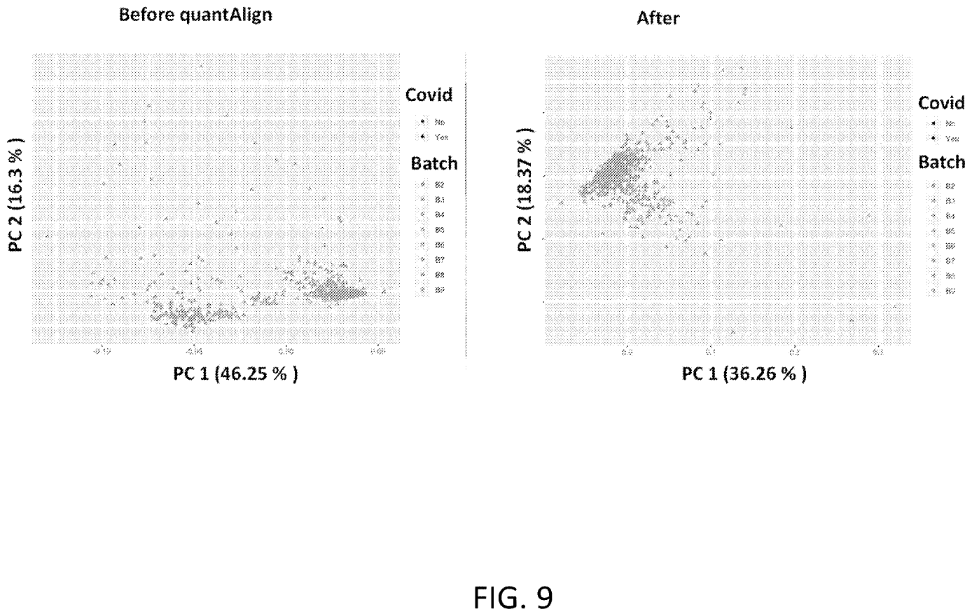

FIG. 7 illustrates exemplary graphs of individual signal intensity ranges for different batches before and after quantile-based adjustment. As illustrated, the signals for a particular metabolite (e.g., gluconate) can exhibit variability across the different batches prior to adjustment. After the adjustment, however, the signal appears equalized across the different batches. Meanwhile, FIG. 8 illustrates exemplary graphs of combined signal intensity ranges by category before and after quantile-based adjustment, whereby the pooled signal is more pronounced and distinct following adjustment. Similarly, FIG. 9 illustrates exemplary combined sets of signal data for different batches before and after quantile-based adjustment. Principal component analysis of the data of different batches shows the quantile-based adjustments result in removal of variability arising from the batch effects.

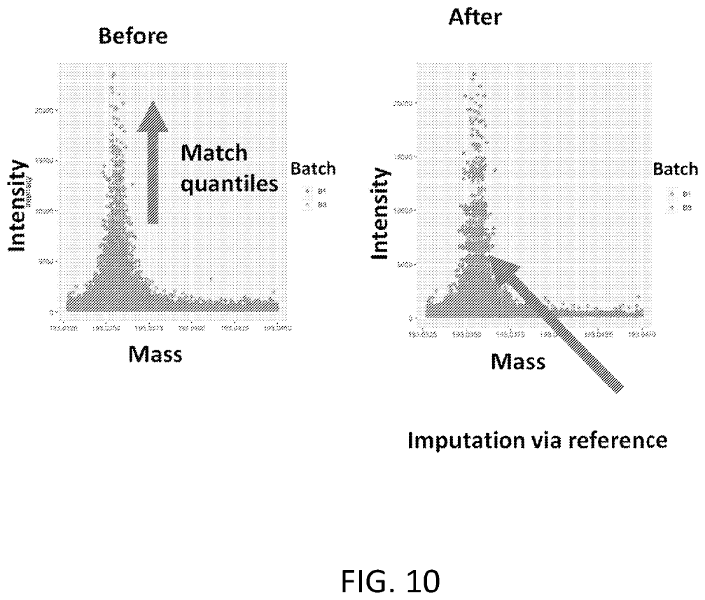

FIG. 10 illustrates exemplary combination maps of signal data for different batches before and after quantile-based adjustment where the adjusted combination map can be used to impute signals. Once the adjustments to match corresponding quantiles within the respective Gaussians are made, the resulting adjusted Gaussian map can be used to impute for missing data in one or more of the batches.

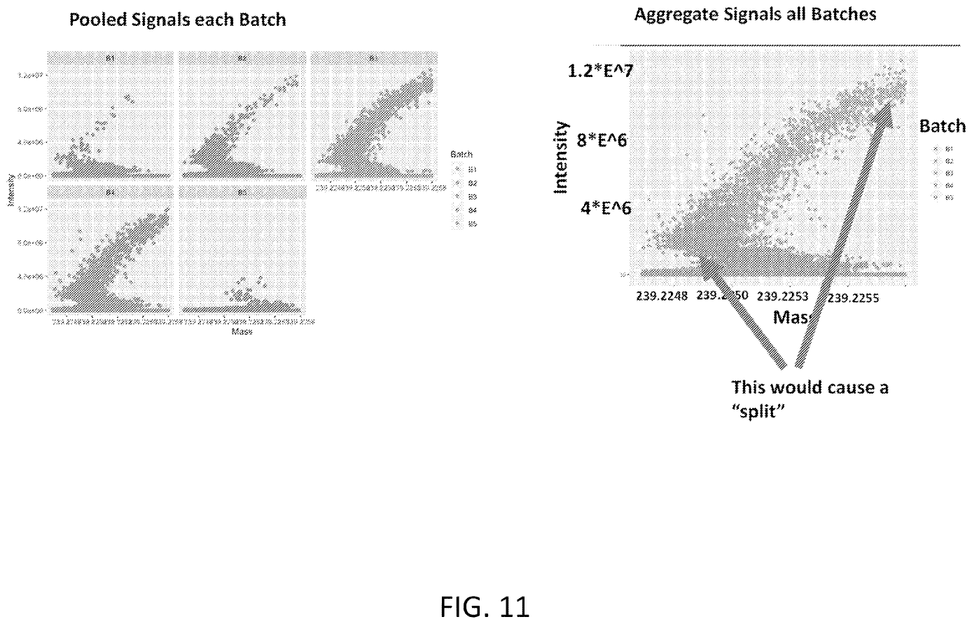

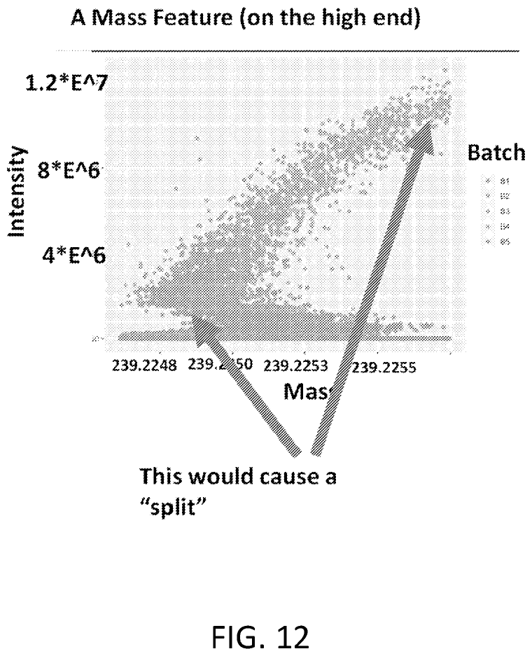

FIG. 11 illustrates exemplary maps of signal data for different individual batches subject to space charge effects and an exemplary combination map of the signal data across the set of batches, and FIG. 12 illustrates a close-up view of the exemplary combination map of the signal data across the set of batches. Such space charge effects can appear when the LC-MS machine is sensitive and/or when the metabolite is abundant. Ions introduced into the LC-MS machine can create ion clouds that are too big and where the ions can repel one another, resulting in space charge (e.g., at the high end of intensity). When mapped, the signals do not appear as a standard Gaussian, but rather exhibit a split where signals at the high end appear to have drifted along the mass domain.

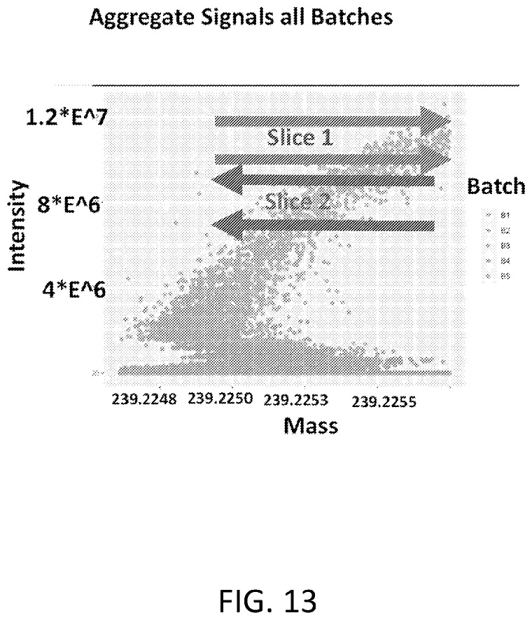

FIG. 13 illustrates exemplary quantile slices within the combination of signal data. As illustrated in FIG. 13, the space charge effects result in signals at the high end of intensity appearing to have drifted to the right along the mass domain. In order to correct for such effects, a different type of quantile-based adjustments can be made to the signal data so as to reverse such drift. As such, each merged data file can be divided into an ordered sequence of quantiles (e.g., from top to bottom of the Gaussian signal intensity profile), and the respective mass-to-charge (m/z) ratios can be determined for each quantile. Where space charge-based drift is present, the average m/z value of that intensity quantile slice will be different from that of the above slice as one descends through the Gaussian signal intensity profile (highest to lowest quantiles of signal intensity),

A space charge correction factor for a first quantile can be determined by comparing its average m/z to the average m/z for the next successive quantile (e.g., the second quantile). The space charge correction factor can be based on a difference in the average m/z value between a given quantile slice and a next quantile slice descending within the Gaussian signal intensity profile. By adjusting each slice based on the space charge correction factor, the difference in average m/z values between slices can be eliminated such that m/z values are stable across the range of intensity values for the metabolite. This results in a stable Gaussian signal profile throughout the intensity range, thereby preventing the skewing of mass determination.

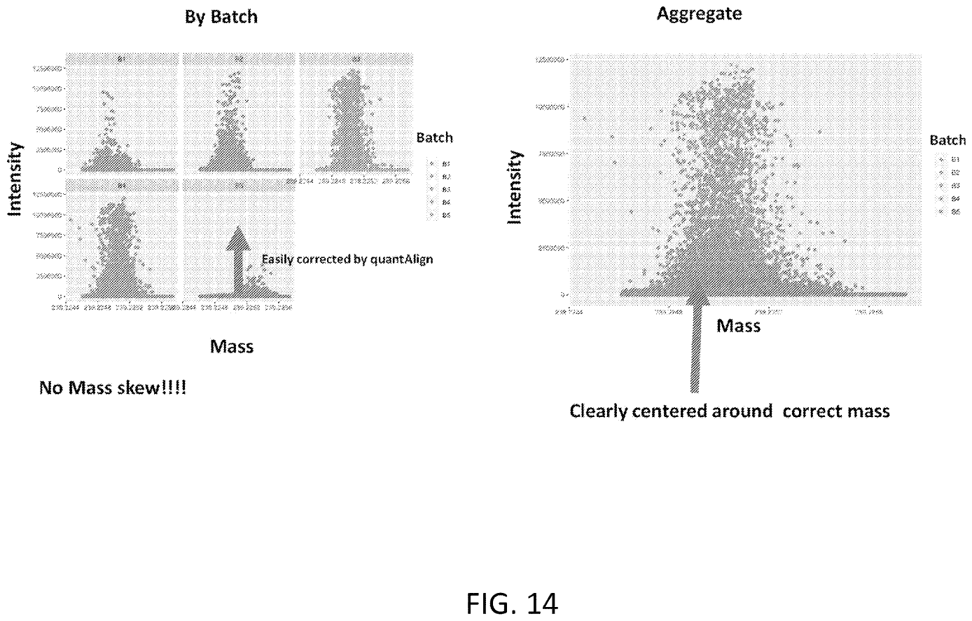

FIG. 14 illustrates adjusted maps of signal data for different individual batches subject to space charge effects and an exemplary combination map of the adjusted signal data across the set of batches. As illustrated in the individual and combination maps, the Gaussian intensity profile no longer exhibits a split along the mass domain but is instead centered around the corrected mass.

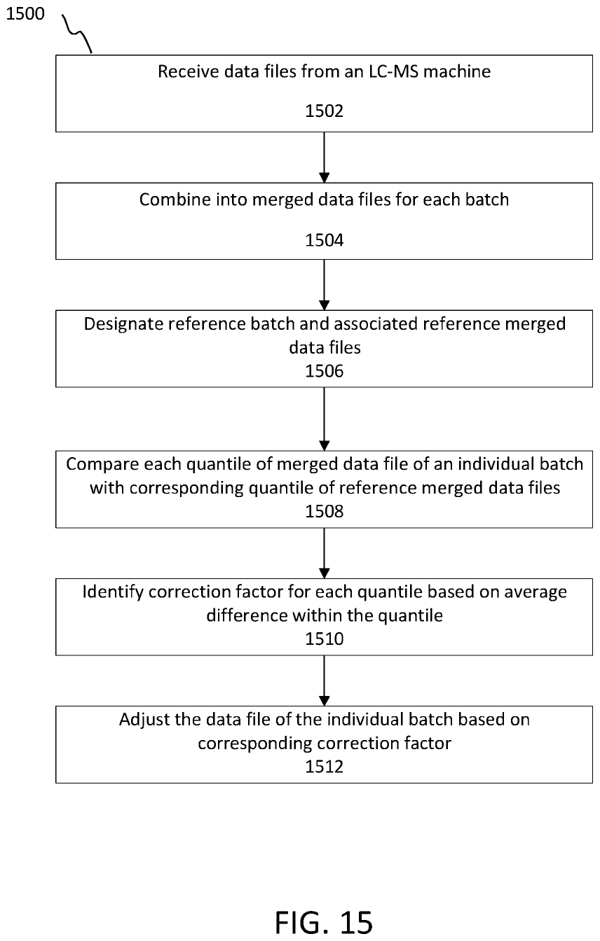

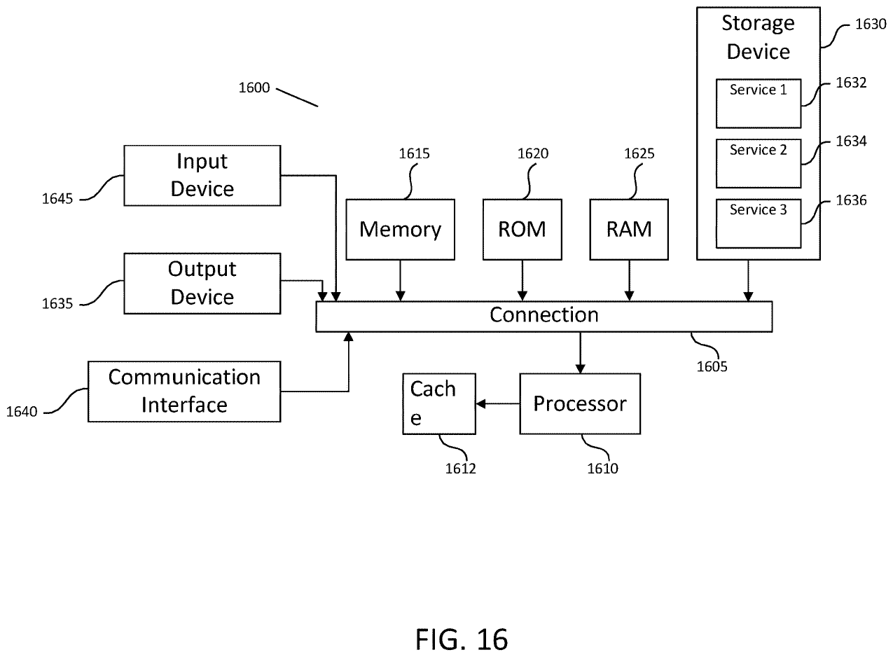

FIG. 15 is a flowchart illustrating an exemplary method 1500 for correcting batch effects of liquid chromatograph-mass spectrometry data files. The method 1500 of FIG. 15 can be embodied as executable instructions in a non-transitory computer readable storage medium including but not limited to a CD, DVD, or non-volatile memory such as a hard drive. The instructions of the storage medium can be executed by a processor (or processors) to cause various hardware components of a computing device (such as described in relation to FIG. 16) hosting or otherwise accessing the storage medium to effectuate the method. The steps identified in FIG. 15 (and the order thereof) are exemplary and can include various alternatives, equivalents, or derivations thereof including but not limited to the order of execution of the same.

In step 1502, multiple data files can be received from an LC-MS machine regarding readings for an individual batch (which can include multiple samples). The data files can include measurements for signals detected by the LC-MS machine. Sets of such signal measurements can be determined to be clustered within certain bounds and identified as mass features (e.g., corresponding to metabolite or other compound). For each mass feature, there can be variations in the Gaussian signal distribution, which can be associated with batch-specific effects such as signal intensity fluctuations and/or space-charge mass drift. The data files for the individual batch can be stored in memory and used to perform analyses in conjunction with data files regarding readings for other batches (e.g., of same tissue being analyzed).

In step 1504, the data files for a given batch can be merged to generate a merged data file that includes a combined set of raw signal measurements from each file of the respective batch. As such, where there are multiple different individual batches, a series of merged data files can be generated.

In step 1506, one of the batches can be designated as the reference batch, and its corresponding merged data file designated as the reference file. The reference batch and corresponding reference file can be used as the reference against which the other batches and merged data files can be compared. Each merged data file (including the reference file) can further be divided into an ordered sequence of quantiles (e.g., from top to bottom of the Gaussian signal intensity profile). For example, a quantile can correspond to a percentile of signal intensity.

In step 1508, each merged data file can be compared to the reference file on a quantile-to-quantile basis. For example, a first quantile of a first merged data file can be compared to a first quantile of the reference file. A comparison can be performed between each quantile of a merged data file for a given batch and a corresponding quantile of the reference file. The quantile comparisons can result in identified signal intensity differences between each quantile of a merged data file for a given batch and a corresponding reference quantile.

In step 1510, a correction factor can be identified for each quantile based on an average of the differences identified for the quantile. For example, an average of differences can be determined for a first quantile based on averaging the respective differences identified between each of the first quantiles of multiple query batches and the first quantile of the reference batch.

In step 1512, the data file of the individual batch can be adjusted in accordance with the quantile correction factors identified in step 1510. Adjusting the data file can include making an adjustment to the signal intensities associated with the respective quantile in accordance with the associated correction factor. The data file of the individual batch can thus be normalized on a quantile-by-quantile basis in accordance with the quantile-specific correction factor, resulting in improved alignment of the corresponding Gaussian signal intensity profile when the adjusted data file is mapped. When such a map is generated, the map visually presents the modified signal measurements of each quantile of the individual batch based on the adjusted data file for an individual batch. Further, an updated combination map can be generated from a plurality of adjusted data files for multiple individual batches. Within such an updated combination map, batch-specific effects have been corrected for, and mass features are less obscured and appear more pronounced.

In some embodiments, the updated combination map can be used to identify one or more imputed signals for the individual batch based on the updated merged data file. In particular, the Gaussian profile can be examined to identify where certain signals are expected to appear, but that can be missing from one or more of the data files of the individual batch.

Such missing signals can nevertheless be imputed by comparing a Gaussian distribution of the updated merged data file to a corresponding Gaussian distribution of the data file of the individual batch.

Batch effects associated with space charge can be indicated by a split along a mass domain of a merged data files particularly for signals associated with higher intensities. Such space charge-based batch effects can be corrected for by applying an adjustment to the data file of the individual batch. The adjustment can include modifying the signal measurements of each quantile of the individual batch based on a mass correction factor. In particular, a plurality of intensity-based quantiles can be identified for the merged data file based on a relationship between mass and intensity. The mass correction factor can be identified based on a difference in average mass-to-charge measurement between the intensity-based quantile and the successive intensity-based quantile. By applying the mass correction factor to adjust the data file, the split effect can be removed from a map of the adjusted data file, which otherwise shows a stable Gaussian signal profile at the correct mass.

### (b) Mass Spectrometry

MS is a powerful analytical tool that can be combined with separation methods such as chromatography (chromatography-MS) for effective detection and quantitation of various compounds in a sample. Chromatography-MS comprises a first separation of components of a sample by chromatography where compounds with different properties separate and are collected at different times. The time point at which a certain fraction of a compound elutes from the column is called the retention time (RT). The resulting fractions are then inserted online into the mass spectrometer. Here the second separation takes place. By ionizing the compounds and accelerating them to fly through a spectrometer, the compounds are separated by their mass-to-charge (m/z) ratio (also referred to herein as “mass” for the sake of simplicity). Accordingly, a plurality of m/z signal intensities can be captured by a mass spectrometer in an output file, while intensity data records the abundance of a species of a given m/z relative to retention time. The measured data can then be depicted in a total ion chromatogram (TIC) 3D image comprising three axes. One axis depicts the RT, the second represents the m/z value, and the third axis represents the intensity or quantity of a peptide. The combined data of RT, m/z value, and intensity for each sample can be obtained as a chromatography-MS data file.

Methods of the instant disclosure comprise detecting and correcting batch effects in chromatography-MS data files. In the context of liquid chromatography-mass spectrometry (LC-MS) data analysis, heat maps can be generated from MS data to visually represent the distribution and intensity of detected signals. The process can comprise evaluation of a batch of multiple samples by an LC-MS machine, which can generate a chromatogram that includes intensity signals along a mass domain and a retention time (RT) domain. These identified signals, such as intensity values, can be saved to data files. Further analysis can comprise mapping these signals in a two-dimensional (2D) ion heat map, where different clusters of signals appear mapped to similar mass and retention times. When signals are summed up across multiple batch samples, the result can include mass features within certain bounds, which can be indicative of specific compounds, such as metabolites, present within the batch sample. In the absence of batch-specific effects, it is expected that samples of the same biological tissue would result in similar mass features. However, batch effects can create variations across different batch evaluation results, making the mass features more difficult to discern. By clustering signals and generating heat maps on a batch-by-batch basis, data can be better analyzed, facilitating the detection and correction of batch effects and improving the accuracy of compound identification. For instance, in the imputing step of the method, the adjusted Gaussian map generated from the clustered signals can be used to identify where certain signals are expected to appear but can be missing from one or more of the data files of the individual batch. By comparing the Gaussian distribution of the updated merged data file to the corresponding Gaussian distribution of the data file of the individual batch, missing signals can be imputed, thereby enhancing the completeness and reliability of the data analysis.

Space charge effects in chromatography-MS are a significant concern, particularly when dealing with highly sensitive instruments or abundant metabolites. These effects arise due to the mutual repulsion between ions of like charge, which can lead to various issues in mass spectrometry data accuracy and quality. Space charge effects are fundamentally a consequence of Coulomb's law, which describes the force between two points charges. When a large number of ions are introduced into the LC-MS machine, they form ion clouds. If these clouds become too dense, the ions repel each other, leading to space charge effects. This repulsion can cause several problems. The repulsion between ions can cause the ion cloud to expand, which can affect the trajectory and distribution of ions within the mass spectrometer. The repulsion can also cause ions to drift along the mass domain, leading to inaccuracies in mass measurements. This is particularly problematic at high ion intensities, where the signals do not follow a standard Gaussian distribution but instead show a split, indicating mass drift.

Space charge effects can impact various types of mass spectrometers differently. In ICP-MS, space charge effects can reduce sensitivity, especially when dealing with a complex mixture of elements. The presence of easily ionized matrix constituents can exacerbate these effects, undermining the utility of the analysis. In FT-MS, space charge effects limit the accuracy of mass measurements. The error in mass measurement is related to the number of ions of each particular mass, and a global correction for the total number of ions is often insufficient. A modified calibration equation is necessary to account for the higher number of ions affected by space charge. In ion-trap mass spectrometers, space charge effects are convoluted with the effects of repeated collisions between ions and the gas (usually helium) present in the trap. This affects the ability to store ions efficiently within the trap, limiting the number of ions that can be stored at any one time. Space charge effects on mass accuracy have been observed in orbitrap mass spectrometers, particularly for ions with high charge states. The dynamic range of the instrument can be affected by space charge, leading to reduced performance at higher m/z values.

Currently available methods that can be used to mitigate space charge effects in chromatography-MS include Automatic Gain Control (AGC), Cleaning and Maintenance, Calibration Methods, and Simulation and Modeling. AGC can help control the ion population by adjusting the sampling time in the ion trap, thereby reducing space charge effects. Cleaning and Maintenance: Ensuring that the orifices and capillaries are clean can help reduce the buildup of charge-sapping salts or compounds that contribute to space charge effects. Regular maintenance and cleaning cycles, including the infusion of methanol and formic acid, can help maintain sensitivity. Using appropriate calibration methods can help account for space charge effects. External calibration methods can account for frequency shifts due to space charge, while internal calibration methods can provide higher mass accuracy by measuring calibrants and analytes under identical conditions. Comprehensive simulations that account for collisions between stored ions and the gas, along with space charge effects, can help predict and mitigate these effects. For example, simulations have shown that space charge effects are most significant when the temperature of the ion cloud is lower. Methods of the instant disclosure can further comprise adjusting space-charge mass drift in a mass feature exhibiting space-charge mass drift by applying a mass-based adjustment to the data file of the individual batch along the mass domain of the mass feature as described in Sections I(a) and (c) herein.

In some embodiments, the methods comprise obtaining or having obtained one or more data files from a chromatography-mass spectrometry machine that has analyzed a sample of unknown compounds. The data in the data file can include a retention time and a mass-to-charge (m/z) signal intensity for each data point in the data file. As methods of the instant disclosure can comprise independently correcting batch effects for each mass features, in some embodiments, a method of the instant disclosure can further comprise identifying or having identified a mass feature most likely to belong to a compound for which an EIC can be extracted. In some embodiments, the m/z value most likely to belong to a compound is identified using methods described in International Application No. PCT/US2022/028150, the disclosure of which is incorporated herein in its entirety.

The methods can be used to correct batch effects in hundreds, to thousands, to hundreds of thousands of EICs extracted from a plurality TICs. The plurality of chromatograms can originate from a diverse range of samples, offering a broad scope for analysis and comparison. These chromatograms can be derived from a single sample, providing a detailed, focused examination of its components. Alternatively, chromatograms can be obtained from multiple samples collected independently, allowing for a comparative analysis across a wider range of variables. This versatility is particularly useful in experiments involving various treatments or conditions. For instance, samples from different treatment groups in a study can be analyzed to compare and contrast the effects of these treatments at a molecular level. Similarly, samples under different experimental conditions can provide insights into how these conditions influence the chemical composition of the samples.

Methods of the instant disclosure can be used to overcome drift in retention times in chromatography-MS runs for untargeted analyses of any compound, including chemical, pharmaceutical, biochemical, and metabolomic compounds. Non-limiting examples of chemical, biochemical, and metabolomic compounds include biochemical compounds such as amino acids, peptides and proteins, nucleotides and nucleosides, DNA and RNA fragments, lipids (fatty acids, triglycerides, phospholipids, steroids), carbohydrates (monosaccharides, disaccharides, polysaccharides), vitamins, hormones, and enzymes; metabolomic compounds such as metabolic intermediates (glycolysis intermediates, Krebs cycle intermediates), neurotransmitters, plant metabolites (alkaloids, terpenes, flavonoids), bacterial and fungal metabolites, endogenous metabolites (bile acids, urea cycle intermediates), and xenobiotics (drugs, toxins); environmental contaminants such as pesticides and herbicides, polycyclic aromatic hydrocarbons (PAHs), persistent organic pollutants (POPs), and heavy metals and metalloids (in their organic forms); pharmaceuticals such as therapeutic drugs, drug metabolites, antibiotics; polymeric materials such as polymers and copolymers, additives and plasticizers, and oligomers; isotopically labeled compounds such as stable isotope labeled metabolites, deuterated compounds; industrial chemicals such as dyes and pigments, surfactants and detergents, and explosives; food and beverage analysis such as food additives, flavor compounds, contaminants; forensic analysis such as illicit drugs, explosive residues, and trace evidence compounds; and geological and cosmochemical analysis such as elemental isotopes, and organic molecules in extraterrestrial samples.

In some embodiments, methods of the instant disclosure can be used to overcome drift in retention times of chromatography-MS runs for analyses of metabolites. While specific types of compounds (e.g., metabolites such as fructose and galactose) can be discussed herein, such discussion of specific embodiments is for illustrative purposes and should not be interpreted as limiting the present disclosure to the specific embodiments being illustrated and discussed.

There are multiple categories of chromatography and MS, wherein each combination of chromatography and MS methods can cater to different analytical needs, depending on the complexity of the sample, the required sensitivity, resolution, and speed of analysis. The choice of technique is often determined by the specific application and the nature of the compounds being analyzed.

Non-limiting examples of major categories of chromatographic techniques that can be coupled with MS include Liquid Chromatography-Mass Spectrometry (LC-MS), Gas Chromatography-Mass Spectrometry (GC-MS), Ion Chromatography-Mass Spectrometry (IC-MS), Supercritical Fluid Chromatography-Mass Spectrometry (SFC-MS), Capillary Electrophoresis-Mass Spectrometry (CE-MS). Liquid chromatography methods can include High-Performance Liquid Chromatography (HPLC)—the most common form, utilizing high pressure to pass the sample through a column filled with stationary phase; Ultra-Performance Liquid Chromatography (UPLC)—similar to HPLC but uses smaller particle sizes in the column for higher resolution and faster analysis; Ion Exchange Chromatography—separates ions based on their affinity to an ion exchanger in the column; Size Exclusion Chromatography (SEC)—separates molecules based on size, using a column with pores of a specific size; Normal Phase Chromatography—uses a polar stationary phase and a non-polar mobile phase; Reverse Phase Chromatography—uses a non-polar stationary phase and a polar mobile phase, opposite to normal phase; Chiral Chromatography—separates enantiomers based on their interaction with a chiral stationary phase; Affinity Chromatography—uses a stationary phase made of materials that specifically bind to the analyte of interest. Gas chromatography methods include Capillary Gas Chromatography—uses very narrow capillary tubes with a liquid stationary phase; Packed Column Gas Chromatography—utilizes columns packed with solid stationary phase or solid support coated with liquid stationary phase; Gas-Solid Chromatography (GSC)—involves a solid stationary phase and is used primarily for separating gases or volatile compounds that don't interact with liquid stationary phases. Ion chromatography is typically used for the separation of ions and polar molecules. Supercritical Fluid Chromatography-Mass Spectrometry (SFC-MS) uses a supercritical fluid (like CO2) as the mobile phase, combining aspects of both GC and LC. It's particularly effective for analyzing compounds that are difficult to separate by traditional LC, such as chiral compounds. Capillary Electrophoresis: Although not technically a chromatographic technique, capillary electrophoresis separates ions based on their charge-to-size ratio in an electric field.

Non-limiting examples of MS include Quadrupole Mass Spectrometry (QMS)—uses quadrupole filters for mass analysis, suitable for a broad range of masses; Time-of-Flight Mass Spectrometry (TOF-MS); separates ions by their different flight times; Ion Trap Mass Spectrometry—traps ions using electromagnetic fields and then sequentially ejects them for mass analysis; Fourier Transform Ion Cyclotron Resonance (FT-ICR)—offers very high resolution and accuracy, using a magnetic field to trap ions; Orbitrap Mass Spectrometry—uses an electrostatic field to trap ions in an orbital motion around a central electrode; Triple Quadrupole Mass Spectrometry (QqQ) which incorporates three quadrupoles in series; commonly used for quantification due to its high sensitivity and specificity; Tandem Mass Spectrometry (MS/MS) which involves multiple stages of mass spectrometry, often with fragmentation of analyte ions between stages; Quadrupole Time-of-Flight Mass Spectrometry (Q-TOF) which combines quadrupole mass filtering with TOF mass analysis for high accuracy and resolution; and Magnetic Sector Mass Spectrometry which uses a magnetic field to deflect ions, with separation based on mass-to-charge ratio.

In some embodiments, methods of the instant disclosure can be used to overcome drift in retention times of LC-MS runs. In some embodiments, methods of the instant disclosure can be used to overcome drift in retention times of LC-MS runs for analyses of metabolites.

In addition to chromatography, different separation techniques can also be used in conjunction with mass spectrometry. Non-limiting examples of suitable separation techniques other than chromatography include electrophoresis, ion mobility, Field-Flow Fractionation (FFF), Capillary Electrophoresis (CE), Matrix-Assisted Laser Desorption/Ionization (MALDI), Thermal Desorption (TD), Laser Ablation (LA), Desorption Electrospray Ionization (DESI). Electrophoresis separates charged particles under an electric field, effectively used for biomolecules like DNA and proteins. Ion mobility spectrometry, on the other hand, separates ions based on their mobility in a gas phase under an electric field, useful for distinguishing isomers and conformers. FFF techniques separate particles, macromolecules, or colloids based on their size or density in a fluid under various field forces (such as centrifugal, thermal, or electrical fields). Coupling FFF with MS allows for the analysis of large and complex molecules like proteins and polymers. CE is similar to electrophoresis but conducted in capillary tubes. CE is effective for separating ionic species using an electric field. Its coupling with MS provides high resolution and efficiency, particularly useful for analyzing biomolecules like peptides and nucleotides. Although MALDI is more of an ionization technique than a separation technique, it is often mentioned in the context of MS coupling. It's particularly useful for the analysis of large biomolecules like proteins, DNA, and polymers. TD involves heating a sample to release volatile and semi-volatile compounds. When coupled with MS, it allows for the analysis of compounds in air, materials, and environmental samples. LA comprises using a laser to remove material from a solid sample. Coupling LA with MS enables the analysis of solid samples, particularly in fields like geology and material science, allowing for elemental and isotopic analysis. DESI allows for the direct analysis of samples (even from surfaces) under ambient conditions. It's useful for a wide range of applications, including biological tissues and environmental samples.

### (c) Embodiments

One embodiment of the instant disclosure encompasses a method for correcting batch effects of liquid chromatograph-mass spectrometry data files. The method comprises: (a) receiving a plurality of data files corresponding to different batches evaluated by a liquid chromatograph-mass spectrometer machine, each data file including a set of signal measurements regarding a corresponding batch as measured by the liquid chromatograph-mass spectrometer machine; (b) combining the received data files for the batches into a series of merged data files that include a combined set of raw signal measurements from each file of each respective batch; (c) designating one of the batches as a reference batch, wherein a merged data file for the reference batch is designated as a reference file; (d) comparing each quantile of the merged data file for each individual batch to a corresponding quantile of the reference file for the reference batch, wherein differences in signal measurements are identified between each quantile of the merged data file for the individual batch and the corresponding quantile of the reference file; (e) identifying a correction factor for each quantile of the individual batch relative to the reference batch, wherein the correction factor corresponds to an average of the differences in signal measurements identified for the respective quantile of the individual batch; and (f) adjusting the data file of the individual batch, wherein adjusting the data file includes modifying the signal measurements of each quantile of the individual batch based on the corresponding correction factor to normalize to signal measurements of the corresponding quantile of the merged reference data files.

The method can further comprise generating a map that visually illustrates the modified signal measurements of each quantile of the individual batch based on the adjusted data file. In some embodiments, the method can further comprise updating the merged data file for the individual batch based on the adjusted data file, wherein generating the map is based on the updated merged data file.

In some embodiments, the method further comprises identifying one or more imputed signals for the individual batch based on the updated merged data file, wherein the imputed signals are missing from one or more of the data files of the individual batch. Identifying the imputed signals can be based on comparing a Gaussian distribution of the updated merged data file to a corresponding Gaussian distribution of the data file of the individual batch.

The method can further comprise identifying each quantile of each individual batch based on signal intensities as indicated by the signal measurements, and modifying the signal measurements includes modifying the signal intensities by the corresponding correction factor. In some embodiments, each batch includes a plurality of samples, and the associated merged data file includes signal measurements for the plurality of samples.

In some embodiments, the method can further comprise identifying a split within the combined set of signal measurements of the merged data file. The identified split can occur along a mass domain of the combined set of signal measurements.

Adjusting the data file of the individual batch can further include applying a mass-based adjustment to the data file of the individual batch along the mass domain. In some embodiment, applying a mass-based adjustment to the data file further comprises identifying a plurality of intensity-based quantiles for the merged data file; and identifying a mass correction factor between one of the intensity-based quantiles and a successive one of the intensity-based quantiles based on a difference in average mass-to-charge measurement between the intensity-based quantile and the successive intensity-based quantile, wherein applying the mass-based adjustment to the data file is based on the mass correction factor identified for each of the intensity-based quantiles.

Another embodiment of the instant disclosure encompasses a method for correcting batch effects of liquid chromatograph-mass spectrometry (chromatography-MS) data files. The method comprises: (a) receiving or having received a plurality of data files corresponding to different batches evaluated by a liquid chromatography-mass spectrometer machine, each data file including a set of signal intensity measurements regarding a corresponding batch as measured by the liquid chromatography-mass spectrometer machine; (b) combining the received data files for each batch into individual merged data files, each merged data file containing a combined set of raw signal intensity measurements from all data files of the respective batch; (c) designating one of the batches as a reference batch, wherein a merged data file for the reference batch is designated as a reference file; (d) comparing each mass-based quantile of the merged data file for each individual batch to a corresponding quantile of the reference file for the reference batch, wherein differences in signal intensity measurements are identified between each mass-based quantile of the merged data file for the individual batch and the corresponding mass-based quantile of the reference file; (e) identifying an intensity correction factor for each mass-based quantile of the individual batch relative to the reference batch, wherein the intensity correction factor reflects the differences in signal intensity measurements identified for the respective mass-based quantile of the individual batch; and (f) adjusting the data file of the individual batch, wherein adjusting the data file includes modifying the signal intensity measurements of each mass-based quantile of the individual batch based on the corresponding intensity correction factor to normalize the signal intensity measurements of the corresponding mass-based quantile of the merged reference data files. In some embodiments, the intensity correction factor corresponds to an average of the differences in signal intensity measurements identified for the respective mass-based quantile of the individual batch.

The method can further comprise performing the adjustments on a mass feature by mass feature basis, wherein each mass feature corresponds to a specific compound present within the batch sample. In some embodiments, each batch includes a plurality of samples, and the associated merged data file includes signal measurements for the plurality of samples. In some embodiments, the method further comprises summing the signal intensity measurements across multiple batch samples to identify mass features within certain bounds, wherein the mass features are indicative of specific compounds present within the batch sample.

The method can further comprise generating a map that visually illustrates the modified signal intensity measurements of each mass-based quantile of the individual batch based on the adjusted data file. The method can also further comprise updating the merged data file for the individual batch based on the adjusted data file. In some embodiments, the method further comprises generating a map based on the updated merged data file.

The method can further comprise identifying one or more imputed signals for the individual batch based on the updated merged data file, wherein the imputed signals are missing from one or more of the data files of the individual batch. In some embodiments, identifying the imputed signals is based on comparing a Gaussian distribution of a mass feature in the updated merged data file to a corresponding Gaussian distribution of the data file of the individual batch.

The method can further comprise adjusting space-charge mass drift in a mass feature exhibiting space-charge mass drift. In some embodiments, adjusting space-charge mass drift in a mass feature exhibiting space-charge mass drift comprises applying a mass-based adjustment to the data file of the individual batch along the mass domain of the mass feature. In some embodiments, adjusting space-charge mass drift in a mass feature exhibiting space-charge mass drift comprises: identifying a plurality of intensity-based quantiles for the merged data file; identifying a mass correction factor for each intensity-based quantile of the individual batch relative to the reference batch, wherein the mass correction factor reflects the differences in mass intensity measurements identified for the respective intensity-based quantile of the individual batch; and applying the mass-based adjustment to the data file based on the mass correction factor identified for each of the intensity-based quantiles. In some embodiments, the mass correction factor corresponds to an average of the differences in intensity measurements identified for the respective intensity-based quantile of the individual batch. In some embodiments, the method further comprises identifying mass features exhibiting space-charge mass drift. In some embodiments, identifying mass features exhibiting space-charge mass drift comprises identifying a split along a mass domain of a mass feature in a merged data file, wherein a split along a mass domain of the mass feature is indicative of space-charge mass drift. In some embodiments, wherein a mass-based adjustment is applied to the data file of the individual batch along the mass domain of the mass feature before correcting batch effects of the data files.

### II. Computing System

Another embodiment of the instant disclosure encompasses a computing system for correcting batch effects of liquid chromatograph-mass spectrometry (chromatography-MS) data files. In some embodiments, the computing system is attached to and/or used in conjunction with a chromatography-MS system. The computing system can comprise several known components and circuitry, including a processor, a memory system, input and output devices and interfaces (e.g., an interconnection mechanism), as well as other components, such as transport circuitry (e.g., one or more busses), a video and audio data input/output (I/O) subsystem, special-purpose hardware, as well as other components and circuitry, as described below in more detail. Further, the computer system(s) can be a multi-processor computer system or can include multiple computers connected over a computer network.

A processor can include one or more general purpose computers, dedicated microprocessors, graphics processors, or other processing devices capable of communicating electronic information. Non-limiting examples of a processor include one or more application-specific integrated circuits (ASICs), graphical processing units (GPUs), field programmable gate arrays (FPGAs), graphics processing units (GPUs), digital signal processors (DSPs) and any other suitable specific or general purpose processors. The processor can be implemented as appropriate in hardware, firmware, or combinations thereof with computer-executable instructions and/or software. Computer-executable instructions and software can include computer-executable or machine-executable instructions written in any suitable programming language to perform the various functions described.

The memory can include more than one memory and can be distributed throughout the computing system. The memory can store program instructions that are loadable and executable on the processor(s) as well as data generated during the execution of these programs. Depending on the configuration and type of memory, the memory can be volatile (such as random access memory (RAM)) and/or non-volatile (such as read-only memory (ROM), flash memory, or other memory). In some embodiments, the memory can include multiple different types of memory, such as static random access memory (SRAM), dynamic random access memory (DRAM), or ROM.

In some embodiments, the computing system can also include additional storage, which can include removable storage and/or non-removable storage. The additional storage can include, but is not limited to, magnetic storage, optical disks, and/or solid-state storage. The disk drives and their associated computer-readable media can provide non-volatile storage of computer-readable instructions, data structures, program modules, and other data for the computing devices. The memory and the additional storage, both removable and non-removable, are examples of computer-readable storage media. For example, computer-readable storage media can include volatile or non-volatile, removable, or non-removable media implemented in any suitable method or technology for storage of information such as computer-readable instructions, data structures, program modules, or other data. As used herein, modules, engines, and components, can refer to programming modules executed by computing systems (e.g., processors) that are part of the architecture.

The processor generally manipulates the data within the integrated circuit memory element in accordance with the program instructions and then copies the manipulated data to the non-volatile recording medium after processing is completed. A variety of mechanisms are known for managing data movement between the non-volatile recording medium and the integrated circuit memory element, and the computing system that implements the methods, steps, systems control and system elements control described above is not limited thereto. The computing system is not limited to a particular memory system.

At least part of such a memory system described above can be used to store one or more data structures (e.g., look-up tables) or equations such as calibration curve equations. For example, at least part of the non-volatile recording medium can store at least part of a database that includes one or more of such data structures. Such a database can be any of a variety of types of databases, for example, a file system including one or more flat-file data structures where data is organized into data units separated by delimiters, a relational database where data is organized into data units stored in tables, an object-oriented database where data is organized into data units stored as objects, another type of database, or any combination thereof.

The computer implemented control system(s) can include one or more output devices. Non-limiting example output devices include a cathode ray tube (CRT) display, liquid crystal displays (LCD) and other video output devices, printers, communication devices such as a modem or network interface, storage devices such as disk or tape, and audio output devices such as a speaker.

The computing system also can include one or more input devices. Example input devices include a keyboard, keypad, track ball, mouse, pen and tablet, communication devices such as described above, and data input devices such as audio and video capture devices and sensors. The computing system is not limited to the particular input or output devices described herein.

It should be appreciated that one or more of any type of computing system can be used to implement various embodiments described herein. Embodiments of the invention can be implemented in software, hardware or firmware, or any combination thereof. The computing system can include specially programmed, special purpose hardware, for example, an application-specific integrated circuit (ASIC). Such special-purpose hardware can be configured to implement one or more of the methods, steps, simulations, algorithms, systems control, and system elements control described above as part of the computer implemented control system(s) described above or as an independent component.

The computing system and components thereof can be programmable using any of a variety of one or more suitable computer programming languages. Such languages can include procedural programming languages, for example, LabView, C, Pascal, Fortran and BASIC, object-oriented languages, for example, C++, Java and Eiffel and other languages, such as a scripting language or even assembly language.

The methods, steps, simulations, algorithms, systems control, and system elements control can be implemented using any of a variety of suitable programming languages, including procedural programming languages, object-oriented programming languages, other languages and combinations thereof, which can be executed by such a computer system. Such methods, steps, simulations, algorithms, systems control, and system elements control can be implemented as separate modules of a computer program or can be implemented individually as separate computer programs. Such modules and programs can be executed on separate computers.

Such methods, steps, simulations, algorithms, systems control, and system elements control, either individually or in combination, can be implemented as a computer program product tangibly embodied as computer-readable signals on a computer-readable medium, for example, a non-volatile recording medium, an integrated circuit memory element, or a combination thereof. For each such method, step, simulation, algorithm, system control, or system element control, such a computer program product can comprise computer-readable signals tangibly embodied on the computer-readable medium that define instructions, for example, as part of one or more programs, that, as a result of being executed by a computer, instruct the computer to perform the method, step, simulation, algorithm, system control, or system element control.

For clarity of explanation, in some instances the present technology can be presented as including individual functional blocks including functional blocks comprising devices, device components, steps or routines in a method embodied in software, or combinations of hardware and software.

Any of the steps, operations, functions, or processes described herein can be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

FIG. 16 illustrates an example of computing system 1600 in which the components of the system are in communication with each other using connection 1605. Connection 1605 can be a physical connection via a bus, or a direct connection into processor 1610, such as in a chipset architecture. Connection 605 can also be a virtual connection, networked connection, or logical connection.

In some embodiments computing system 600 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 1600 includes at least one processing unit (CPU or processor) 1610 and connection 1605 that couples various system components including system memory 1615, such as read only memory (ROM) and random access memory (RAM) to processor 1610. Computing system 1600 can include a cache of high-speed memory connected directly with, in close proximity to, or integrated as part of processor 1610.

Processor 1610 can include any general purpose processor and a hardware service or software service, such as services 1632, 1634, and 1636 stored in storage device 1630, configured to control processor 1610 as well as a special-purpose processor where software instructions are incorporated into the actual processor design. Processor 1610 can essentially be a completely self-contained computing system, containing multiple cores or processors, a bus, memory controller, cache, etc. A multi-core processor can be symmetric or asymmetric.

To enable user interaction, computing system 1600 includes an input device 1645, which can represent any number of input mechanisms, such as a microphone for speech, a touch-sensitive screen for gesture or graphical input, keyboard, mouse, motion input, speech, etc. Computing system 1600 can also include output device 1635, which can be one or more of a number of output mechanisms known to those of skill in the art. In some instances, multimodal systems can enable a user to provide multiple types of input/output to communicate with computing system 1600. Computing system 1600 can include communications interface 1640, which can generally govern and manage the user input and system output. There is no restriction on operating on any particular hardware arrangement and therefore the basic features here can easily be substituted for improved hardware or firmware arrangements as they are developed.

Storage device 1630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 1630 can include software services, servers, services, etc., that when the code that defines such software is executed by the processor 1610, it causes the system to perform a function. In some embodiments, a hardware service that performs a particular function can include the software component stored in a computer-readable medium in connection with the necessary hardware components, such as processor 1610, connection 1605, output device 1635, etc., to carry out the function.

For clarity of explanation, in some instances the present technology can be presented as including individual functional blocks including functional blocks comprising devices, device components, steps or routines in a method embodied in software, or combinations of hardware and software.

Any of the steps, operations, functions, or processes described herein can be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

One embodiment of the instant disclosure encompasses a system for correcting batch effects of liquid chromatograph-mass spectrometry results. The system comprises: a communication interface that communicates over a communication network to receive a plurality of data files corresponding to different batches evaluated by a liquid chromatograph-mass spectrometer machine, each data file including a set of signal measurements regarding a corresponding batch as measured by the liquid chromatograph-mass spectrometer machine; and a processor that executes instructions stored in memory. The processor executes the instructions to: combine the received data files for each batch into a series of merged data files that include a combined set of raw signal measurements for each file of the respective batch, wherein one of the batches is designated as a reference batch, and wherein merged data files for the reference batch are designated as reference files; compare each quantile of the merged data file for each other batch to a corresponding quantile of the reference batch, wherein differences in signal measurements are identified between each quantile of the individual batch and the corresponding quantile of the reference files; identify a correction factor for each quantile of the individual batch relative to the reference batch, wherein the correction factor corresponds to an average of the differences in signal measurements identified for the respective quantile of the individual batch; and adjust the data file of the individual batch, wherein adjusting the data file includes modifying the signal measurements of each quantile of the individual batch based on the corresponding correction factor to normalize to signal measurements of the corresponding quantile of the merged reference data files.

In some embodiments, the processor executes further instructions to generate a map that visually illustrates the modified signal measurements of each quantile of the individual batch based on the adjusted data file. In some embodiments, the processor executes further instructions to update the merged data file for the individual batch based on the adjusted data file, wherein generating the map is based on the updated merged data file. In some embodiments, the processor executes further instructions to identify one or more imputed signals for the individual batch based on the updated merged data file, wherein the imputed signals are missing from the data file of the individual batch. Identifying the imputed signals can be based on comparing a Gaussian distribution of the updated merged data file to a corresponding Gaussian distribution of the data file of the individual batch. In some embodiments, the processor executes further instructions to identify each quantile of each individual batch based on signal intensities as indicated by the signal measurements, wherein modifying the signal measurements includes modifying the signal intensities by the corresponding correction factor. Each batch can include a plurality of samples, and the associated data file can include signal measurements for the plurality of samples.

In some embodiments, the processor executes further instructions to identify a split within the combined set of signal measurements of the merged data file, wherein the identified split occurs along a mass domain of the combined set of signal measurements. In some embodiments, adjusting the data file of the individual batch further includes applying a mass-based adjustment to the data file of the individual batch along the mass domain. In some embodiments, the processor executes further instructions to: identify a plurality of intensity-based quantiles for the merged data file; and identify a mass correction factor between one of the intensity-based quantiles and a successive one of the intensity-based quantiles based on a difference in average mass-to-charge measurement between the intensity-based quantile and the successive intensity-based quantile, wherein applying the mass-based adjustment to the data file is based on the mass correction factor identified for each of the intensity-based quantiles.

Another embodiment of the instant disclosure encompasses a computing system for correcting batch effects of liquid chromatograph-mass spectrometry (chromatography-MS) data files. The system comprises: (a) a communication interface that receives EICs of portions of each of a plurality of MS chromatograms; and (b) a processor that executes instructions stored in memory. The processor executes the instructions to: (i) receive or having received a plurality of data files corresponding to different batches evaluated by a liquid chromatography-mass spectrometer machine, each data file including a set of signal intensity measurements regarding a corresponding batch as measured by the liquid chromatography-mass spectrometer machine; (ii) combine the received data files for each batch into individual merged data files, each merged data file containing a combined set of raw signal intensity measurements from all data files of the respective batch; (iii) designate one of the batches as a reference batch, wherein a merged data file for the reference batch is designated as a reference file; (iv) compare each mass-based quantile of the merged data file for each individual batch to a corresponding quantile of the reference file for the reference batch, wherein differences in signal intensity measurements are identified between each mass-based quantile of the merged data file for the individual batch and the corresponding mass-based quantile of the reference file; (v) identify an intensity correction factor for each mass-based quantile of the individual batch relative to the reference batch, wherein the intensity correction factor reflects the differences in signal intensity measurements identified for the respective mass-based quantile of the individual batch; and (vi) adjust the data file of the individual batch, wherein adjusting the data file includes modifying the signal intensity measurements of each mass-based quantile of the individual batch based on the corresponding intensity correction factor to normalize the signal intensity measurements of the corresponding mass-based quantile of the merged reference data files. The intensity correction factor can correspond to an average of the differences in signal intensity measurements identified for the respective mass-based quantile of the individual batch.

In some embodiments, the processor further executes the instructions to perform the adjustments on a mass feature by mass feature basis, wherein each mass feature corresponds to a specific compound present within the batch sample. Each batch can include a plurality of samples, and wherein the associated merged data file includes signal measurements for the plurality of samples. In some embodiments, the processor further executes the instructions to sum the signal intensity measurements across multiple batch samples to identify mass features within certain bounds, wherein the mass features are indicative of specific compounds present within the batch sample. In some embodiments, the processor further executes the instructions to generate a map that visually illustrates the modified signal intensity measurements of each mass-based quantile of the individual batch based on the adjusted data file.

The processor can further execute the instructions to update the merged data file for the individual batch based on the adjusted data file. In some embodiments, the processor further executes the instructions to generate a map based on the updated merged data file. In some embodiments, the processor further executes the instructions to identify one or more imputed signals for the individual batch based on the updated merged data file, wherein the imputed signals are missing from one or more of the data files of the individual batch. In some embodiments, identifying the imputed signals is based on comparing a Gaussian distribution of a mass feature in the updated merged data file to a corresponding Gaussian distribution of the data file of the individual batch.

In some embodiments, the processor further executes the instructions to adjust space-charge mass drift in a mass feature exhibiting space-charge mass drift. Adjusting space-charge mass drift in a mass feature exhibiting space-charge mass drift can comprise applying a mass-based adjustment to the data file of the individual batch along the mass domain of the mass feature. In some embodiments, adjusting space-charge mass drift in a mass feature exhibiting space-charge mass drift comprises: identifying a plurality of intensity-based quantiles for the merged data file; identifying a mass correction factor for each intensity-based quantile of the individual batch relative to the reference batch, wherein the mass correction factor reflects the differences in mass intensity measurements identified for the respective intensity-based quantile of the individual batch; and applying the mass-based adjustment to the data file based on the mass correction factor identified for each of the intensity-based quantiles. In some embodiments, the mass correction factor corresponds to an average of the differences in intensity measurements identified for the respective intensity-based quantile of the individual batch. In some embodiments, the processor further executes the instructions to identify mass features exhibiting space-charge mass drift. Identifying mass features exhibiting space-charge mass drift can comprise identifying a split along a mass domain of a mass feature in a merged data file, wherein a split along a mass domain of the mass feature is indicative of space-charge mass drift. In some embodiments, the mass-based adjustment is applied to the data file of the individual batch along the mass domain of the mass feature before correcting batch effects of the data files.

Yet another embodiment of the instant disclosure encompasses a non-transitory computer-readable storage medium, having embodied thereon a program executable by a processor to perform a method for correcting batch effects of liquid chromatograph-mass spectrometry results. The method comprises: receiving a plurality of data files corresponding to different batches evaluated by a liquid chromatograph-mass spectrometer machine, each data file including a set of signal measurements regarding a corresponding batch as measured by the liquid chromatograph-mass spectrometer machine; combining the received data files for the batches into a series of merged data files that include a combined set of raw signal measurements from each file of each respective batch; designating one of the batches as a reference batch, wherein a merged data file for the reference batch is designated as a reference file; comparing each quantile of the merged data file for each individual batch to a corresponding quantile of the reference file for the reference batch, wherein differences in signal measurements are identified between each quantile of the merged data file for the individual batch and the corresponding quantile of the reference file; identifying a correction factor for each quantile of the individual batch relative to the reference batch, wherein the correction factor corresponds to an average of the differences in signal measurements identified for the respective quantile of the individual batch; and adjusting the data file of the individual batch, wherein adjusting the data file includes modifying the signal measurements of each quantile of the individual batch based on the corresponding correction factor to normalize to signal measurements of the corresponding quantile of the merged reference data files.

An additional embodiment of the instant disclosure encompasses a non-transitory, computer-readable storage medium, having embodied thereon a program executable by a processor to perform a method for correcting batch effects of liquid chromatograph-mass spectrometry (chromatography-MS) data files. The method comprises: receiving or having received a plurality of data files corresponding to different batches evaluated by a liquid chromatography-mass spectrometer machine, each data file including a set of signal intensity measurements regarding a corresponding batch as measured by the liquid chromatography-mass spectrometer machine; combining the received data files for each batch into individual merged data files, each merged data file containing a combined set of raw signal intensity measurements from all data files of the respective batch; designating one of the batches as a reference batch, wherein a merged data file for the reference batch is designated as a reference file; comparing each mass-based quantile of the merged data file for each individual batch to a corresponding quantile of the reference file for the reference batch, wherein differences in signal intensity measurements are identified between each mass-based quantile of the merged data file for the individual batch and the corresponding mass-based quantile of the reference file; identifying an intensity correction factor for each mass-based quantile of the individual batch relative to the reference batch, wherein the intensity correction factor reflects the differences in signal intensity measurements identified for the respective mass-based quantile of the individual batch; and adjusting the data file of the individual batch, wherein adjusting the data file includes modifying the signal intensity measurements of each mass-based quantile of the individual batch based on the corresponding intensity correction factor to normalize the signal intensity measurements of the corresponding mass-based quantile of the merged reference data files.

In some embodiments, the intensity correction factor corresponds to an average of the differences in signal intensity measurements identified for the respective mass-based quantile of the individual batch.

The method can further comprise performing the adjustments on a mass feature by mass feature basis, wherein each mass feature corresponds to a specific compound present within the batch sample.

The method can further comprise performing the adjustments on a mass feature by mass feature basis, wherein each mass feature corresponds to a specific compound present within the batch sample. In some embodiments, each batch includes a plurality of samples, and the associated merged data file includes signal measurements for the plurality of samples. In some embodiments, the method further comprises summing the signal intensity measurements across multiple batch samples to identify mass features within certain bounds, wherein the mass features are indicative of specific compounds present within the batch sample.

The method can further comprise generating a map that visually illustrates the modified signal intensity measurements of each mass-based quantile of the individual batch based on the adjusted data file. The method can also further comprise updating the merged data file for the individual batch based on the adjusted data file. In some embodiments, the method further comprises generating a map based on the updated merged data file.

The method can further comprise identifying one or more imputed signals for the individual batch based on the updated merged data file, wherein the imputed signals are missing from one or more of the data files of the individual batch. In some embodiments, identifying the imputed signals is based on comparing a Gaussian distribution of a mass feature in the updated merged data file to a corresponding Gaussian distribution of the data file of the individual batch.

The method can further comprise adjusting space-charge mass drift in a mass feature exhibiting space-charge mass drift. In some embodiments, adjusting space-charge mass drift in a mass feature exhibiting space-charge mass drift comprises applying a mass-based adjustment to the data file of the individual batch along the mass domain of the mass feature. In some embodiments, adjusting space-charge mass drift in a mass feature exhibiting space-charge mass drift comprises: identifying a plurality of intensity-based quantiles for the merged data file; identifying a mass correction factor for each intensity-based quantile of the individual batch relative to the reference batch, wherein the mass correction factor reflects the differences in mass intensity measurements identified for the respective intensity-based quantile of the individual batch; and applying the mass-based adjustment to the data file based on the mass correction factor identified for each of the intensity-based quantiles. In some embodiments, the mass correction factor corresponds to an average of the differences in intensity measurements identified for the respective intensity-based quantile of the individual batch. In some embodiments, the method further comprises identifying mass features exhibiting space-charge mass drift. In some embodiments, identifying mass features exhibiting space-charge mass drift comprises identifying a split along a mass domain of a mass feature in a merged data file, wherein a split along a mass domain of the mass feature is indicative of space-charge mass drift. In some embodiments, wherein a mass-based adjustment is applied to the data file of the individual batch along the mass domain of the mass feature before correcting batch effects of the data files.

Although a variety of examples and other information was used to explain embodiments within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### DEFINITIONS

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

As used herein, the term “batch effect” refers to systematic variations in chromatography-MS data that arise when samples are processed in different batches, rather than being due to the biological or chemical differences of interest. In the context of chromatography-MS, batch effects can manifest as variations in signal intensity, retention time, or mass-to-charge ratios across different batches, potentially obscuring true biological signals and complicating data analysis. These effects can result from differences in instrument conditions, sample preparation, or other procedural inconsistencies.

As used herein, the term “merged data file” or “data file” for short, is a combined set of raw signal measurements from multiple data files corresponding to different batches evaluated by a chromatography-MS machine. Each merged data file includes the aggregated signal intensity measurements along with retention time and m/z signals from all data files of the respective batch, facilitating the comparison and correction of batch effects across different batches.

As used herein, the terms “mass-based quantile” and “intensity-based quantile” refer to specific divisions of data within a merged data file based on different criteria. The term “mass-based quantile” is a division of the merged data file based on the mass-to-charge (m/z) ratios of the signal measurements. Each mass-based quantile represents a specific range of m/z values, allowing for the comparison and correction of signal intensity measurements within that range across different batches. The term “intensity-based quantile” is a division of the merged data file based on the signal intensity measurements. Each intensity-based quantile represents a specific range of signal intensities, allowing for the comparison and correction of mass-to-charge (m/z) measurements within that range across different batches.

As used herein, the term “mass correction factor” refers to a value determined for each intensity-based quantile of an individual batch relative to a reference batch. The mass correction factor corresponds to an average of the differences in mass-to-charge (m/z) measurements identified between the respective intensity-based quantile of the individual batch and the corresponding intensity-based quantile of the reference batch. This factor is used to adjust the mass-to-charge (m/z) measurements of each intensity-based quantile in the individual batch to normalize them to the mass-to-charge (m/z) measurements of the corresponding intensity-based quantile in the reference batch, thereby correcting for space-charge mass drift and other mass-related batch effects.

As used herein, the term “intensity correction factor” refers to a value determined for each mass-based quantile of an individual batch relative to a reference batch. The intensity correction factor corresponds to an average of the differences in signal intensity measurements identified between the respective mass-based quantile of the individual batch and the corresponding mass-based quantile of the reference batch. This factor can be used to adjust the signal intensity measurements of each mass-based quantile in the individual batch to normalize them to the signal intensity measurements of the corresponding mass-based quantile in the reference batch, thereby correcting for batch effects.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there can be additional elements other than the listed elements.

As various changes could be made in the above-described cells and methods without departing from the scope of the invention, it is intended that all matter contained in the above description and in the examples given below, shall be interpreted as illustrative and not in a limiting sense.

What is claimed is:

1. A method for correcting batch effects of chromatograph-mass spectrometry (chromatography-MS) data files, the method comprising:
a. receiving or having received a plurality of data files corresponding to different batches evaluated by a liquid chromatography-mass spectrometer machine, each data file including a set of signal intensity measurements regarding a corresponding batch as measured by the liquid chromatography-mass spectrometer machine;
b. combining the received data files for each batch into individual merged data files, each merged data file containing a combined set of raw signal intensity measurements from all data files of the respective batch;
c. designating one of the batches as a reference batch, wherein a merged data file for the reference batch is designated as a reference file;
d. comparing each mass-based quantile of the merged data file for each individual batch to a corresponding quantile of the reference file for the reference batch, wherein differences in signal intensity measurements are identified between each mass-based quantile of the merged data file for the individual batch and the corresponding mass-based quantile of the reference file;
e. identifying an intensity correction factor for each mass-based quantile of the individual batch relative to the reference batch, wherein the intensity correction factor reflects the differences in signal intensity measurements identified for the respective mass-based quantile of the individual batch; and
f. adjusting the data file of the individual batch, wherein adjusting the data file includes modifying the signal intensity measurements of each mass-based quantile of the individual batch based on the corresponding intensity correction factor to normalize the signal intensity measurements of the corresponding mass-based quantile of the merged reference data files.

2. The method of claim 1, wherein the intensity correction factor corresponds to an average of the differences in signal intensity measurements identified for the respective mass-based quantile of the individual batch.

3. The method of claim 1, further comprising performing the adjustments on a mass feature by mass feature basis, wherein each mass feature corresponds to a specific compound present within the batch sample.

4. (canceled)

5. The method of claim 1, further comprising summing the signal intensity measurements across multiple batch samples to identify mass features within certain bounds, wherein the mass features are indicative of specific compounds present within the batch sample.

6. The method of claim 1, further comprising generating a map that visually illustrates the modified signal intensity measurements of each mass-based quantile of the individual batch based on the adjusted data file.

7. The method of claim 1, further comprising updating the merged data file for the individual batch based on the adjusted data file.

8. (canceled)

9. The method of claim 1, further comprising identifying one or more imputed signals for the individual batch based on the updated merged data file, wherein the imputed signals are missing from one or more of the data files of the individual batch, wherein identifying the imputed signals is based on comparing a Gaussian distribution of a mass feature in the updated merged data file to a corresponding Gaussian distribution of the data file of the individual batch.

10. (canceled)

11. The method of claim 1, further comprising adjusting space-charge mass drift in a mass feature exhibiting space-charge mass drift.

12. The method of claim 11, wherein adjusting space-charge mass drift in a mass feature exhibiting space-charge mass drift comprises applying a mass-based adjustment to the data file of the individual batch along the mass domain of the mass feature.

13. The method of claim 11, wherein adjusting space-charge mass drift in a mass feature exhibiting space-charge mass drift comprises:
a. identifying a plurality of intensity-based quantiles for the merged data file;
b. identifying a mass correction factor for each intensity-based quantile of the individual batch relative to the reference batch, wherein the mass correction factor reflects the differences in mass intensity measurements identified for the respective intensity-based quantile of the individual batch; and
c. applying the mass-based adjustment to the data file based on the mass correction factor identified for each of the intensity-based quantiles.

14. (canceled)

15. The method of claim 11, further comprising identifying mass features exhibiting space-charge mass drift, wherein identifying mass features exhibiting space-charge mass drift comprises identifying a split along a mass domain of a mass feature in a merged data file, wherein a split along a mass domain of the mass feature is indicative of space-charge mass drift.

16-17. (canceled)

18. A computing system for correcting batch effects of liquid chromatograph-mass spectrometry (chromatography-MS) data files, the system comprising:
a. a communication interface that receives EICs of portions of each of a plurality of MS chromatograms; and
b. a processor that executes instructions stored in memory, wherein the processor executes the instructions to:
i. receive or having received a plurality of data files corresponding to different batches evaluated by a liquid chromatography-mass spectrometer machine, each data file including a set of signal intensity measurements regarding a corresponding batch as measured by the liquid chromatography-mass spectrometer machine;
ii. combine the received data files for each batch into individual merged data files, each merged data file containing a combined set of raw signal intensity measurements from all data files of the respective batch;
iii. designate one of the batches as a reference batch, wherein a merged data file for the reference batch is designated as a reference file;
iv. compare each mass-based quantile of the merged data file for each individual batch to a corresponding quantile of the reference file for the reference batch, wherein differences in signal intensity measurements are identified between each mass-based quantile of the merged data file for the individual batch and the corresponding mass-based quantile of the reference file;
v. identify an intensity correction factor for each mass-based quantile of the individual batch relative to the reference batch, wherein the intensity correction factor reflects the differences in signal intensity measurements identified for the respective mass-based quantile of the individual batch; and
vi. adjust the data file of the individual batch, wherein adjusting the data file includes modifying the signal intensity measurements of each mass-based quantile of the individual batch based on the corresponding intensity correction factor to normalize the signal intensity measurements of the corresponding mass-based quantile of the merged reference data files.

19-27. (canceled)

28. The computing system of claim 18, wherein the processor further executes the instructions to adjust space-charge mass drift in a mass feature exhibiting space-charge mass drift, wherein adjusting space-charge mass drift in a mass feature exhibiting space-charge mass drift comprises applying a mass-based adjustment to the data file of the individual batch along the mass domain of the mass feature, wherein adjusting space-charge mass drift in a mass feature exhibiting space-charge mass drift comprises:
a. identifying a plurality of intensity-based quantiles for the merged data file;
b. identifying a mass correction factor for each intensity-based quantile of the individual batch relative to the reference batch, wherein the mass correction factor reflects the differences in mass intensity measurements identified for the respective intensity-based quantile of the individual batch; and
c. applying the mass-based adjustment to the data file based on the mass correction factor identified for each of the intensity-based quantiles.

29-34. (canceled)

35. A non-transitory, computer-readable storage medium, having embodied thereon a program executable by a processor to perform a method for correcting batch effects of liquid chromatograph-mass spectrometry (chromatography-MS) data files, the method comprising:
a. receiving or having received a plurality of data files corresponding to different batches evaluated by a liquid chromatography-mass spectrometer machine, each data file including a set of signal intensity measurements regarding a corresponding batch as measured by the liquid chromatography-mass spectrometer machine;
b. combining the received data files for each batch into individual merged data files, each merged data file containing a combined set of raw signal intensity measurements from all data files of the respective batch;
c. designating one of the batches as a reference batch, wherein a merged data file for the reference batch is designated as a reference file;
d. comparing each mass-based quantile of the merged data file for each individual batch to a corresponding quantile of the reference file for the reference batch, wherein differences in signal intensity measurements are identified between each mass-based quantile of the merged data file for the individual batch and the corresponding mass-based quantile of the reference file;
e. identifying an intensity correction factor for each mass-based quantile of the individual batch relative to the reference batch, wherein the intensity correction factor reflects the differences in signal intensity measurements identified for the respective mass-based quantile of the individual batch; and
f. adjusting the data file of the individual batch, wherein adjusting the data file includes modifying the signal intensity measurements of each mass-based quantile of the individual batch based on the corresponding intensity correction factor to normalize the signal intensity measurements of the corresponding mass-based quantile of the merged reference data files.

36-44. (canceled)

45. The non-transitory, computer-readable storage medium of claim 35, the method further comprising adjusting space-charge mass drift in a mass feature exhibiting space-charge mass drift, wherein adjusting space-charge mass drift in a mass feature exhibiting space-charge mass drift comprises applying a mass-based adjustment to the data file of the individual batch along the mass domain of the mass feature, wherein adjusting space-charge mass drift in a mass feature exhibiting space-charge mass drift comprises:
a. identifying a plurality of intensity-based quantiles for the merged data file;
b. identifying a mass correction factor between one of the intensity-based quantiles and a successive one of the intensity-based quantiles based on a difference in average mass-to-charge measurement between the intensity-based quantile and the successive intensity-based quantile; and
c. applying the mass-based adjustment to the data file based on the mass correction factor identified for each of the intensity-based quantiles.

46-50. (canceled)
